(19) United States
(12) Patent Application Publication
(10) Pub. No.: US 2008/0035616 A1
(43) Pub. Date: Feb. 14, 2008

(54) Laser-marking system

(75) Inventors: Udo Muller, Fuchsstadt (DE); Peter Schmitt, Wurzburg (DE)

Correspondence Address: K.F. ROSS P.C., 5683 RIVERDALE AVENUE, SUITE 203 BOX 900, BRONX, NY, 10471-0900, US

(73) Assignee: KBA-METRONIC AG

(21) Appl. No.: 11/891,156

(22) Filed: Aug. 9, 2007

(30) Foreign Application Priority Data
Aug. 11, 2006 (DE) 102006037921.7

(51) Int. Cl. B23K 26/38; B23K 26/00

(52) U.S. Cl. 219/121.68; 219/121.72

(57) ABSTRACT

An apparatus for laser marking an arcuate surface of an object has a laser source emitting a laser beam and a first reflector assembly for deflecting the beam in a contiguous first field. A second reflector assembly has at least two adjacent second reflectors in the first field for reflecting the beam into at least two separate and not overlapping second fields. Respective third reflectors in the second fields reflect the beam in the respective third fields onto respective adjacent portions of the surface of the object.

### FIELD OF THE INVENTION

The present invention relates to laser marking. More particularly this invention concerns a method of an apparatus for laser marking or engraving.

### BACKGROUND OF THE INVENTION

A laser-marking apparatus is frequently used in industrial production facilities and other applications, for example to directly inscribe products or packaging therefor as well as foods and dietary preparations with various information and markings. These usually involve alphanumeric characters, logos, or bar codes by means of which an end user or an automatic scanner, for example, may identify the product or the product expiration date or manufacturer.

In addition, it is becoming increasingly common to mark everyday products with lasers, for example to produce decorations on the surface of a product or the packaging therefor, by means of which the product or its packaging is made more attractive or identified with respect to its producer, so that at a glance a user may associate this product type and design with the corresponding manufacturer.

The marking itself is achieved by the action of a focused laser beam on the product or package surface. To do this either a previously applied color is removed, the surface is vaporized and/or melted and/or carbonized, or by means of a color modification, in particular when specialized pigments have been introduced beforehand into the surface to be marked, or by deeper vaporization of the surface, resulting in an engraving. In any case, the aim is to produce the highest possible visual and/or tactile contrast with the surrounding background in order to improve legibility.

This type of marking is carried out by CO₂ laser or Nd:YAG laser, for example. The marking is produced either in the mask shot process by use or by deflecting the laser beam with a galvanometer scanner, or by use of an optical crystal. With the exception of the mask shot process, the referenced laser marking methods are freely programmable and thus allow variable marking from product to product.

For this purpose, in addition to the deflection unit the available freely programmable marking apparatuses such as, for example, those operating by use of a galvanometer scanner, have additional optical elements like lenses by means of which the laser beam is focused at a focal plane. The marking is then advantageously performed on this focal plane, since at this location the focal spot of the laser beam is at its minimal dimension and thus the laser intensity is at its maximum, so that essentially only in this plane does the laser energy absorbed by the material to be marked result in marking.

Depending on the laser power, wavelength, type of laser operation, and absorption characteristics of the material to be marked in the wavelength region under consideration, marking may also be carried out above and below the focal plane. Nonetheless, past a certain spacing from the focal plane in these regions the surface power density of the laser radiation decreases to the extent that marking is no longer possible. In addition the focal spot of the laser enlarges with increasing distance from the focal plane, so that a clear, high-resolution marking is no longer practical, even with sufficient power density. In the region to be marked, laser marking is thus limited to an essentially planar surface whose roughness, curvature, or structure must lie within narrow limits for the reasons stated.

Marking of a larger surface, for example a spherical or cylindrical surface or in general the surface of an object having one or more strongly concave or convex curvatures, as a rule is achieved only by dividing the image into multiple partial images and positioning the object with respect to the marking laser for each partial image in such a way that each partial image is within the above-referenced limits and can thus be marked in an effective manner. The overall image is then composed of the partial images. It is obvious that, in particular at the edges of the partial images, a highly accurate fit must be achieved in order to obtain a self-contained image. To this end, for each partial image the object must be precisely aligned with the marking apparatus, which involves significant technical effort and expenditure of time.

### OBJECTS OF THE INVENTION

It is therefore an object of the present invention to provide an improved laser-marking system.

Another object is the provision of such an improved laser-marking system that overcomes the above-given disadvantages, in particular that achieves a high-quality marking even for strongly curved and elongated surfaces without having to perform complex manual or automatic movements of either the marking apparatus or the object to be marked.

### SUMMARY OF THE INVENTION

An apparatus for laser marking an arcuate surface of an object has according to the invention a laser source emitting a laser beam and a freely programmable first laser-beam reflector assembly for deflecting the beam in a contiguous first field. A second reflector assembly has at least two adjacent second reflectors in the first field for reflecting the beam into at least two separate and not overlapping second fields. Respective third reflectors in the second fields reflect the beam in the respective third fields onto respective adjacent portions of the surface of the object.

The object is further achieved by a method wherein at least one second reflector assembly deflects a laser beam into at least two nonoverlapping second fields after deflection by a freely programmable first laser-beam reflector assembly, and by means of a third reflector assembly a laser beam is deflected from each second field into a respective third field in the direction of an object to be deflected, whereby the third fields at least partially overlap or intersect, so that an object situated at overlap or intersection of the third fields is marked by laser beams from at least two fields.

An essential core idea of the invention is that by use of a method according to the invention or an apparatus according to the invention an object, in particular a fixed and stationary object, to be marked is marked not just from one field, but instead from multiple fields, in particular at least two fields. In this manner marking on a curved surface of an object to be marked may be optimized without having to realign the object to be marked.

The designs from the prior art have resulted in only one focal plane, since a laser beam strikes an object to be marked essentially from only one direction, or, on account of the deflection, from only one field. If the surface of this object has a strong curvature, this surface is only partially situated in the focal plane. By irradiating an object from at least two fields, the position of the surface of the object to be marked may be better optimized with respect to the multiple focal planes that then result. A larger contiguous region of the curved surface of an object may thus be marked, in particular when the surface is essentially cylindrical or spherical.

A laser beam is thus initially deflected by means of a programmable first reflector assembly to achieve a desired marking. This may be carried out using a galvanometer scanner or any other suitable apparatus.

To this end, the image of a marking may be created beforehand in a higher-level control system, for example by use of a graphics program on a computer. Such an image may be stored as a vector graphic, for example. If desired, the image created on a monitor that typically is essentially flat may be distorted by means of software as a function of a curved surface of an object to be marked, such that after the marking, the curved surface when viewed from only one direction does not appear to have a distorted appearance to the observer.

The image of a marking is essentially traversed by a laser beam like a scanner. Depending on the deflection, the beam that is deflected by the first reflectors is then deflected into at least two different second fields by means of a second reflector assembly. These different second fields are obtained, for example, when the beam deflected by the programmable deflection unit strikes the second reflector assembly in different regions. If the laser beam strikes a first region of the second reflector assembly, the laser beam is deflected into a second field, and if the laser beam strikes the reflector assembly in another region it is deflected into another second field, and so forth.

Preferably none of the second fields intersect. When there are only two fields, one of them may be reversed or inverted relative to the other.

The second reflector assembly may be formed, for example, by at least two planar mirrors that are oriented at an angle relative to one another, in particular such that the mirrors contact at adjacent edges. Each of the mirrors forms one region of the reflector assembly in the meaning described above. The number of mirrors specifies the number of different second fields that are possible. To obtain two second fields, a reflector assembly may be formed, for example, by two mirrors oriented at an angle of 90° to one another, in particular such that two edges of both mirrors make contact and the edge may be oriented toward the programmable deflection unit. To obtain four second fields, for example, a reflector assembly may be formed by four mirrors oriented in a pyramid, this configuration being provided with the tip of the pyramid pointed toward the programmable deflection unit.

Because the individual possible second fields that thus all originate in the second reflector assembly diverge away from one another, according to the invention each laser beam is deflected from one of the previously defined second fields into a third field. Thus, a third field is associated with each of the second fields into which a laser beam may be deflected. The deflection is performed by respective third reflectors in such a way that a laser beam that advances in a third field strikes a surface portion to be marked on an object. Thus, depending on the programmed deflection, such an object is illuminated from (at least two) different third fields to make a marking on the curved surface. It is preferred that these third fields at least partially intersect or overlap.

To make the desired marking, an object is thus advantageously positioned such that a surface to be marked is situated in the region of intersection or overlap of the separate third fields.

According to the invention, a marking, in particular an continuous marking, in the surface of an object may be composed of a number of partial markings that corresponds to the number of second and third fields, each partial marking being applied to the surface from another field.

By means of a higher-level control system such as software, an overall marking may first be broken down into partial markings, and the resultant partial markings may then be applied to the surface.

The apparatus according to the invention may be adjusted in such a way that the partial markings directly adjoin one another to form a contiguous marking, that is one with its parts fitting together and forming a single image. By marking a region, in particular a small region, of the overall marking by means of a laser beam that strikes at a different angle (from another field), it is possible to mark each partial marking within the respective allowable focal depth region, and thus to create an overall marking that as a whole has a sharply defined marking over the entire curved surface.

A same or different number of individual markings corresponding to the number of fields may also be applied according to the invention to the surface of an object. Thus, after marking, an object may have the same or different images at various positions, for example.

The partial markings may also be inverted and/or reversed with a marking in a higher-level control system, for example when the third fields intersect above the surface, in particular a concave surface, to be marked, so that the partial markings are combined into an overall marking on the correct side of the surface of the object to be marked.

In principle, the marking may be carried out using parallel unfocused laser beams. However, it is preferred that the laser beams are focused in such a way that in each of the third fields the region on the surface of an object to be marked is provided in a focal depth region surrounding the focal plane.

For this purpose, at least one focusing element, in particular a lens or a curved or dished mirror, may be provided in the beam path of the laser beam. Different focusing elements, in particular having different focal distances, may also be provided for each of the individual fields. The second and/or third reflector assembly-may preferably be designed for direct focusing, in particular as a curved or dished mirror. If a lens is provided as the focusing element, a reflector assembly may be designed as a planar deflection mirror.

By means of the invention it is possible to mark objects having any given curved surface, in particular concave or convex surfaces. The beam paths of the laser beams from the first reflector assembly, via the various reflector assemblies, to the object may essentially always be the same, or also different.

In all designs of the invention, at least one additional third reflector assembly and optionally a fourth reflector assembly essentially of the same type may also be provided downstream from at least one second reflector assembly.

The workpiece or object may have an essentially spherical or cylindrical surface. For a cylindrical object, irradiation with laser beams may be performed from two different fields aligned essentially perpendicular to the cylindrical axis. References to angles relate to a beam in the center of the respective field.

### BRIEF DESCRIPTION OF THE DRAWING

The above and other objects, features, and advantages will become more readily apparent from the following description, reference being made to the accompanying drawing in which:

FIGS. 1 and 2 show a prior-art system marking a flat and a part-spherical surface of an object;

FIG. 3 shows the system according to the invention for marking a convex portion cylindrical outer surface; and

FIG. 4 shows a system like that of FIG. 3, but marking a cylindrical concave surface of an object.

### SPECIFIC DESCRIPTION

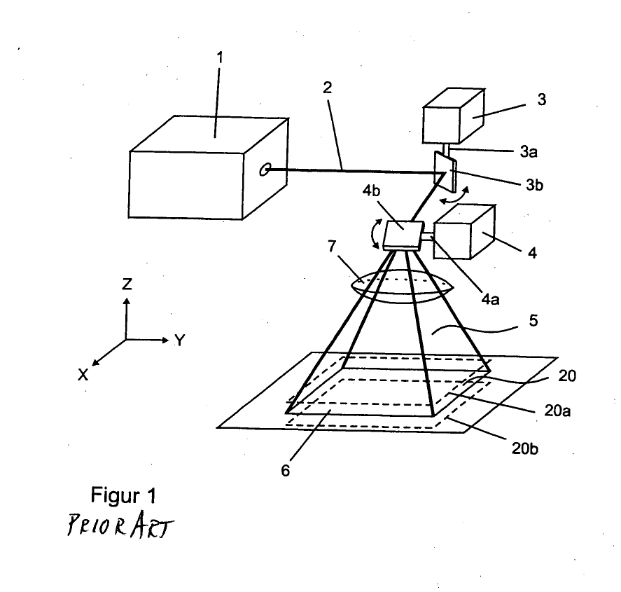

As seen in FIG. 1 a known system for laser marking uses a galvanometer scanner. A laser beam 2 generated by a laser emitter 1 is deflected in the x and y directions by means of a freely programmable control system (not illustrated) via deflection mirrors 3b and 4b attached on respective perpendicular axes 3a and 4a of the galvanometer scanners 3 and 4 such that a marking cone 5 is formed that in turn defines a marking field 6.

A focusing lens 7 in the beam path focuses the laser beam 2 at a focal plane 20 on which the laser beam has its focal point and thus its minimum extension in the x and y directions, so that the laser power at the surface is at a maximum. It is necessary for marking that the surface to be marked be placed on this plane, since the most effective marking having the sharpest contour is obtained at this location due to the minimum focal point and the resulting maximum power density.

Displacement of the surface to be marked along the z axis away from the focal plane 20 causes enlargement of the focal point, and thus a quadratic-reduction in the power density, so that satisfactory marking results are obtained only within a focal depth range between upper boundary plane 20a and a lower boundary plane 20b. Outside this region the achievable marking results are unsatisfactory, or marking is not possible at all.

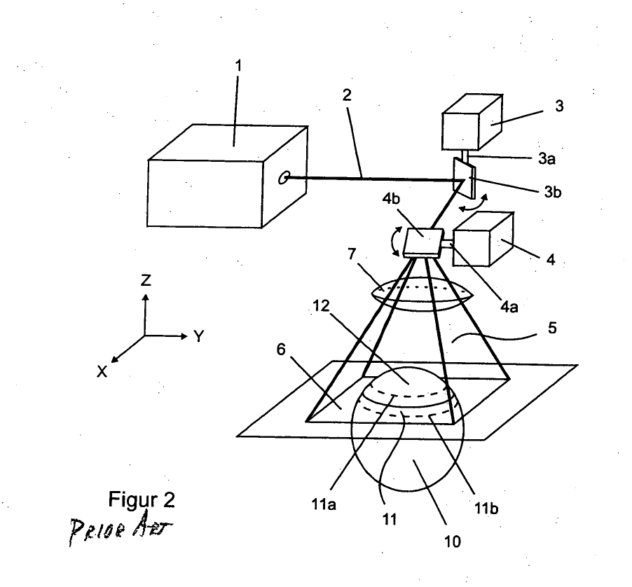

If as shown in FIG. 2 a strongly curved surface 10 is to be inscribed over a large area, it is no longer possible to keep all of the regions of the surface 10 to be inscribed within an allowable region 11, delimited by an upper boundary plane 11a and a lower boundary plane 11b (focal depth region), which is practical for inscription. Instead, at least one region 12 of the surface 10 to be inscribed does not lie in the region 11, so that this region cannot be satisfactorily inscribed or cannot be inscribed at all, or, according to the prior art as previously described, must be inscribed using partial images in one or more further operations.

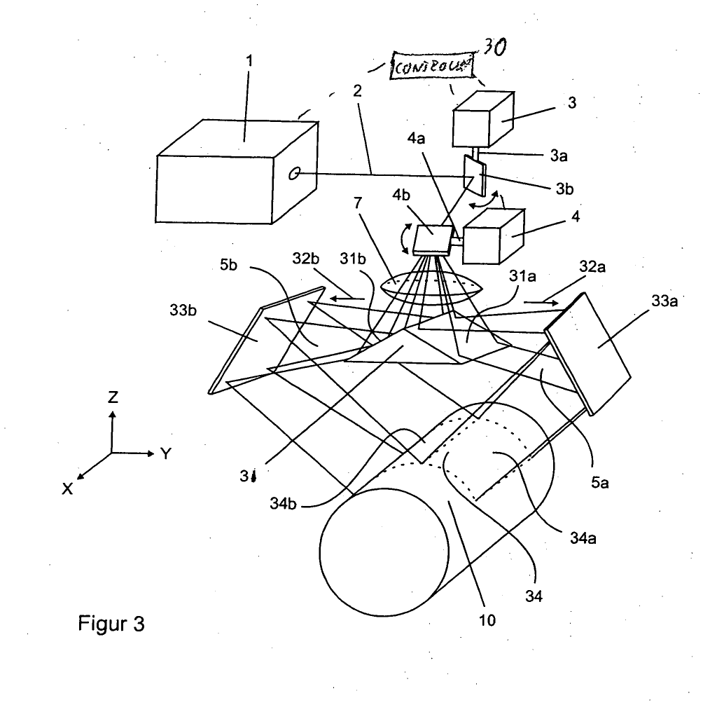

FIG. 3 shows a first embodiment according to the invention. The laser beam 2 generated by a laser beam source 1 is deflected in the x and y directions by means of a freely programmable controller 30 operating the deflection mirrors 3b and 4b attached on the axes 3a and 4a of the galvanometer scanners 3 and 4, and is focused in a focal plane by means of a subsequent focusing lens 7. On the output side of the lens 7 is a mirror-type optical reflector assembly 31 by means of which the laser beam 2 exiting the lens 7 at different angles, depending on the upstream x and y deflection, is deflected into at least two different second fields 5a and 5b.

When, for example, two deflection mirrors 31a and 31b are used in the mirror system 31 define a given angle, for example 90°, and form a prism-shaped reflector, for example, a laser beam 2 incident on the mirrored surface 31a or 31b is deflected either in direction 32a or 32b, depending on the previous deflection, so that in this example two marking cones 5a and 5b result that form different second fields.

By means of the respective third reflector assembly, composed of deflection mirrors 33a and 33b, provided downstream, these marking cones 5a and 5b are deflected in such a way that the surface of the object 10 to be inscribed, composed of different third fields, is marked in the partial areas 34a and 34b such that the partial areas combine to form a common marking surface 34.

The distance of the respective partial areas 34a and 34b from the focusing lens 7 corresponds to the focal distance of the lens 7 used, so that each partial area 34a and 34b essentially lies in the focal plane. For this purpose, the deflection mirrors 33a and 33b may be displaceably and/or rotatably attached in a mount (not illustrated) in order to conform the respective distances of the partial areas to be inscribed to the marking lens 7.

When objects that essentially are always the same are inscribed, this adjustment is made once. In addition, for a suitable choice of the directions of impingement for the marking cones 5a and 5b on the surface of the object 10 to be marked, the respective partial areas 34a and 34b lie within the allowable focal depth, so that the entire marking in the marking surface 34 as a whole lies within the allowable focal depth, and a high-quality marking is thus possible. Of course, the marking cone may also be split into more than the two partial cones stated as an example, for example into three, four, or more partial cones, in order to inscribe spherical or conical surfaces.

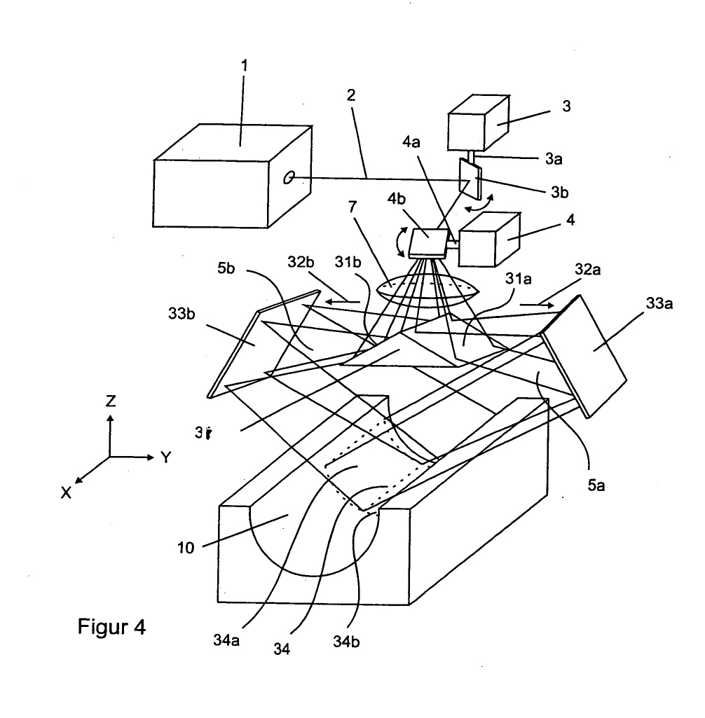

In an alternative embodiment according to the invention, it is also possible to mark elongated concave surfaces as shown in FIG. 4. The configuration is essentially the same as that described in FIG. 3, except for the geometric position of the partial areas 34a and 34b with respect to one another on the surface 10 of the object to be inscribed. In this case, the marking cones (third fields) cross each other so that the partial areas likewise are switched with one another in an intersection region. In order to create a self-contained marking image 34 on the correct side, in this case the respective partial images must be switched in the marking software for the marking unit and also reversed.

It may also be practical to omit a marking lens 7. In this case the deflection mirrors 31a and 31b and/or 33a and 33b are designed as curved mirrors so that the laser beam 2 is similarly focused in a focal plane lying essentially on the surface of the object to be inscribed. The curved mirrors may have spherical, parabolic, hyperbolic, or similar designs, or may also be off-axis mirrors, depending on requirements.

For the inscription, any laser is suitable that has a wavelength, power, and operating system that allows adequate marking in each particular case, for example gas lasers such as CO₂ lasers, argon lasers, metal vapor lasers, ion lasers, excimer lasers, etc., or semiconductor lasers or solid-state lasers such as Nd:solid-state lasers, ruby lasers, alexandrite lasers, sapphire lasers, or also free-electron lasers.

We claim:

1. An apparatus for laser marking an arcuate surface of an object, the apparatus comprising:
a laser source emitting a laser beam;
first reflector means for deflecting the beam in a contiguous first field;
second reflector means having at least two adjacent second reflectors in the first field for reflecting the beam into two separate and not overlapping at least second fields; and
respective third reflectors in the second fields for reflecting the beam in the respective third fields onto respective adjacent portions of the surface of the object.

2. The laser-marking apparatus defined in claim 1 wherein there are more than two second reflectors forming more than two second fields and more than two third reflectors reflecting the beams in more than two third fields onto more than two respective adjacent portions of the surface of the object.

3. The laser-marking apparatus defined in claim 1, further comprising
at least one focusing optical element preferably a lens or curved mirror in the first field between the first and second reflector means.

4. The laser-marking apparatus defined in claim 1, further comprising:
at least one movable or tiltable focusing optical element in the first field between the first and second reflector means.

5. The laser-marking apparatus defined in claim 1 wherein at least one of the reflectors is a focusing reflector.

6. The laser-marking apparatus defined in claim 1 wherein the reflectors are flat and planar.

7. The laser-marking apparatus defined in claim 1 wherein the reflectors are movable or tiltable.

8. The laser-marking apparatus defined in claim 1 wherein the laser beam is focused in each of the third fields onto a corresponding portion of the surface of the object such that the portion of the surface of the object lie within a focal depth.

9. The laser-marking apparatus defined in claim 1 wherein the object surface is concave.

10. The laser-marking apparatus defined in claim 1 wherein the object surface is convex.

11. A method of laser marking an arcuate surface of an object, the method comprising the steps of:
emitting a laser beam;
deflecting the beam in a contiguous first field;
reflecting the beam into at least two separate and not overlapping second fields with at least two adjacent second reflectors in the first field; and
reflecting the beam in the respective third fields onto respective adjacent portions of the surface of the object with respective third reflectors in the second fields.

12. The laser-marking method defined in claim 11 wherein information to be marked is split into a number of partial markings, the number being equal to the number of second fields.

13. The laser-marking method defined in claim 12 wherein the partial markings are interchanged or laterally reversed.
